(19) United States
(12) Patent Application Publication
(10) Pub. No.: US 2010/0028515 A1
(43) Pub. Date: Feb. 4, 2010

(54) RE-CARBONATING DEVICE

(76) Inventor: Michael Gormley, Bournemouth (GB)

Correspondence Address: ADAMS INTELLECTUAL PROPERTY LAW, Suite 2350 Charlotte Plaza, 201 South College Street, CHARLOTTE, NC, 28244, US

(21) Appl. No.: 12/519,998

(22) PCT Filed: Nov. 7, 2007
(86) PCT No.: PCT/IB2007/054525

§ 371 Date: Jun. 18, 2009

(30) Foreign Application Priority Data
Dec. 18, 2006 (GB) 0625158.1

(51) Int. Cl. A23L 2/54

(52) U.S. Cl. 426/477; 99/323.1

(57) ABSTRACT

A carbonated drink container pressurizer adapter that is screwed onto a conventional drink container in place of the original bottle top, which includes a valve attachment point for the purpose of allowing entry of CO₂, and a pressure release valve preset to open at a given pressure for the safe use of the adapter.

### CROSS-REFERENCE TO RELATED APPLICATIONS

This application claims priority to International Application No. PCT/IB2007/054525 filed Nov. 7, 2007, and Great Britain Application No. 0625158.1 filed Dec. 18, 2006, the contents of which are incorporated by reference herein.

### TECHNICAL FIELD AND BACKGROUND OF THE INVENTION

1. Field of the Invention

The present invention relates generally to a device that improves the quality of carbonated beverages in containers once opened.

2. Background of the Invention

When conventional carbonated drink bottles are opened and a part of the content of the beverage consumed, the remaining liquid begins to lose its CO₂ content. As more of the drink is consumed, more CO₂ is lost. Generally the loss of CO₂ is most significant after half to two thirds of the contents are gone. The remaining amount of beverage is then still substantial, but not good to drink. The amount of CO₂ remaining in the beverage is also dependent on the length of time the bottle is stood without its headspace pressurized by carbon dioxide.

### SUMMARY OF THE INVENTION

To overcome this, the present invention proposes to supply a replacement top through which CO₂ may be delivered into the bottle (or other re-closable vessel).

The top may have a protruding nozzle, enabling the easy connection of a suitable CO₂ source.

Preferably, the source of the CO₂ is a CO₂ cartridge. CO₂ cartridges of the type used as bicycle tire inflators may be used, for example.

The introduction of pressurized CO₂ to the beverage will stop the evolution of CO₂ from the product (detrimental to its desired characteristic of “fizziness”) by equalizing the process of evolution by simultaneous absorption. In other words, it will keep the beverage from going flat.

An essential feature of this device is a valve that allows for simple connection and operation. When the CO₂ source is a bicycle tire inflator it has a connector adapted to be coupled to a tire valve. The replacement top likewise may have such a valve. Suitably, a Schrader valve may be used as it is the male connection, common to most bicycle inflators.

An essential feature of this device is, it has contained within, a pressure relief valve set at x bar to allow for misuse by the general public, without any endangerment to them or others.

Preferably, the replacement top has a pressure relief valve to prevent over pressurization within the container. This relief valve might typically be set between 2.068 bar and 2.413 bar.

Preferably, the replacement top and/or the CO₂ source comprises control means under the control of a user, for controlling the flow of CO₂ into the vessel. The control means may provide flow/no flow control and/or flow rate control.

Suitably, the replacement top has means for forming and sealing the connection with the neck of the bottle. Preferably, it has the same such means as the top being replaced. Most commonly this will be a screw thread carried on the inside of a downwardly depending skirt.

In a first aspect, the present invention provides a replacement top, as defined.

In a second aspect, the present invention provides a vessel (preferably a bottle) containing a carbonated beverage, and fitted with said replacement top, in place of the as-supplied cap.

In a third aspect, a CO₂ source is coupled to the replacement top.

In a fourth aspect, the present invention provides a method of re-carbonating carbonated beverage supplied in a re-sealable vessel, including replacing the as-supplied closure of the vessel with a replacement top of the first aspect, and supplying one or more charge of CO₂ as and when required.

### BRIEF DESCRIPTION OF THE DRAWINGS

These and other features, aspects and advantages of the present invention are better understood when the following detailed description of the invention is read with reference to the accompanying drawings, in which:

FIG. 1 is a perspective view of the bottle top pressurizer adapter. It shows the association of the invention to the threaded bottle neck.

FIG. 2 is a vertical section view of the bottle top pressurizer adapter showing the invention internally.

### DETAILED DESCRIPTION OF THE INVENTION

The adapter is designed specifically for use with a commercially available CO₂ bicycle tire inflator, available from many high street cycle shops. These tire inflators use a 16 gram CO₂ cartridge, which delivers the CO₂ charge. The adapter replaces the original bottle top, once the bottle has been opened. It is often the case that with carbonated beverages supplied in 1, 2 and 3 liter bottles the contents are not all consumed at once. With this invention, when an amount of the beverage has been poured, the original bottle top is discarded and the bottle top pressurizer adapter screwed onto the bottle in its place. A bicycle tire CO₂ inflator fitted with a food grade 16 gram CO₂ cartridge is then pressed up against valve on the side of the adaptor and CO₂ is delivered either by depressing a trigger or by the inflator head being depressed which itself activates the flow of CO₂. The user may release the trigger or the inflator head as appropriate, to terminate the delivery of CO₂. Enough CO₂ is delivered to make the walls of the bottle rigid once more, or until the pressure release valve is activated. This charge of CO₂ will create an equilibrium of loss and absorption of CO₂ from the remaining liquid within the headspace of the bottle with the net effect being, no loss of effervescence (fizz) by the beverage.

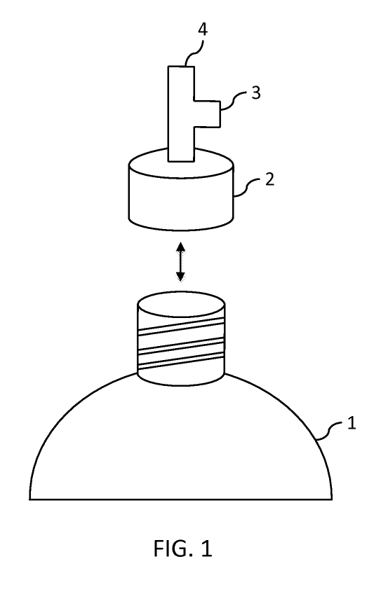

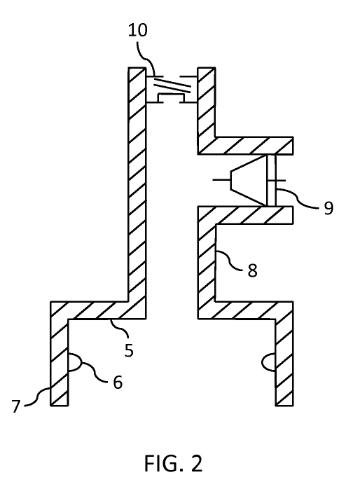

Referring to the figures, FIG. 1 shows the adapter 2 which is representative of the present invention, associated with the bottle 1 formed from a plastic, which is common to most 1, 2 and 3 litre bottles commonly available. In FIG. 2, the cylindrical body of the replacement bottle top adapter 7, is hollow and has an internal thread 6 that mates up with the external thread on the bottle neck. On the underside of the top potion of this cylindrical body is a rubber seal 5 which enables an airtight seal upon closure, much as the original bottle top would provide. Protruding from this main cylindrical body is a hollow “T” shaped tube, which allows for the delivery of the charge of CO₂. At the topmost end 4 there is fitted a pressure release valve 10 to ensure the safety of the device, and in the horizontal portion of the “T” shaped tube at 3 there is a short core Schrader valve 9. This horizontal portion of the “T” shaped tube 3 is the male component to which the CO₂ bicycle tire inflator is attached.

While a re-carbonating device has been described with reference to specific embodiments and examples, it is envisioned that various details of the invention may be changed without departing from the scope of the invention. Furthermore, the foregoing description of the preferred embodiments of the invention and best mode for practicing the invention are provided for the purpose of illustration only and not for the purpose of limitation.

What is claimed is:

1. A device enabling re-carbonation of a carbonated beverage in a re-sealable vessel, the device serving as a replacement of an as-supplied closure of the vessel, the device comprising:
means for sealing and closing the vessel to produce a thru-sealed vessel; and
means to permit delivery of CO₂ into the thru-sealed vessel from a pressurized source.

2. A device as claimed in claim 1, further comprising means for preventing over pressurization within the vessel.

3. A device as claimed in claim 1, wherein the means to permit delivery of CO₂ is a valve adapted to be coupled with an outlet of a CO₂ cartridge.

4. A device as claimed in claim 3, wherein the valve adapted to be coupled to the outlet of a CO₂ cartridge is a Schrader valve, and the CO₂ cartridge to be coupled to the Schrader valve is a bicycle tire inflator.

5. A device according to claim 1, wherein the device seals a pouring opening of the vessel.

6. A device according to claim 1, wherein the device is coupled to a CO₂ cartridge.

7. A device enabling re-carbonation of a carbonated beverage in a re-sealable vessel and serving as a replacement of an as-supplied closure of the vessel, the device comprising:
a hollow cylindrical body defining internal threading for engaging external threading of a neck of the vessel and including a rubber seal for providing a seal between the cylindrical body and the neck of the vessel; and
a hollow T-shaped tube projecting vertically upwardly from the cylindrical body for delivering a charge of CO₂ into the vessel, the T-shaped tube including a pressure release valve fitted within the uppermost end of the T-shaped tube, and a short core Schrader valve for attaching a pressurized CO₂ source fitted in a horizontal extending branch of the T-shaped tube.

8. A method of re-carbonating a beverage in a vessel, comprising:
replacing an as-supplied closure of the vessel with a device comprising means for sealing and closing the vessel to produce a thru-sealed vessel, and means to permit delivery of CO₂ into the thru-sealed vessel from a pressurized source;
connecting a CO₂ cartridge to the device; and
supplying one or more charges of CO₂ from the cartridge to the vessel as needed.
